(19) United States
(12) Patent Application Publication
(10) Pub. No.: US 2008/0079554 A1
(43) Pub. Date: Apr. 3, 2008

(54) VEHICLE IMPACT CAMERA SYSTEM

(76) Inventor: STEVEN JAMES BOICE, Austin, TX (US)

Correspondence Address: STEVEN J. BOICE, 1902 STONERIDGE ROAD, AUSTIN, TX, 78746, US

(21) Appl. No.: 11/537,802

(22) Filed: Oct. 2, 2006

(51) Int. Cl. B60Q 1/00; H04N 7/18

(52) U.S. Cl. 340/436; 348/148

(57) ABSTRACT

In order to enable an owner of an unattended parked vehicle to identify a party that struck the owner's unattended parked vehicle, the present invention provides for a method, system and computer-readable medium for integrating operation of an on-board recorder with one or more vehicle-mounted cameras. Whenever an impact of sufficient strength is detected by an impact detector on a vehicle, feed from one or more vehicle-mounted cameras, which have a field of view that encompasses the striking vehicle, is sent to the on-board video recorder. The feed can also be sent to a remote receiver, such as a computer, a Personal Digital Assistant (PDA), a video-enabled cell phone, or a law enforcement monitor.

### BACKGROUND OF THE INVENTION

1. Technical Field

The present invention relates in general to the field of vehicles, and more particularly to vehicles equipped with impact detectors. Still more particularly, the present invention relates to a video recording device for unattended vehicles that have been struck by another vehicle.

2. Description of the Related Art

It is a common occurrence for vehicles to be damaged while parked in a public parking lot. That is, an unattended parked vehicle is often struck by another vehicle, shopping cart, person, etc., which/who then leaves the accident scene without acknowledging responsibility for the impact. The owner of the vehicle is therefore left with no recourse against the guilty party.

### SUMMARY OF THE INVENTION

In order to enable an owner of an unattended parked vehicle to identify a party that struck the owner's unattended parked vehicle, the present invention provides for a method, system and computer-readable medium for integrating operation of an on-board recorder with one or more vehicle-mounted cameras. Whenever an impact of sufficient strength is detected by an impact detector on a vehicle, feed from one or more vehicle-mounted cameras, which have a field of view that encompasses the striking vehicle, is sent to the on-board video recorder. The feed can also be sent to a remote receiver, such as a computer, a Personal Digital Assistant (PDA), a video-enabled cell phone, or a law enforcement monitor.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIGS. 1A-B depict a vehicle with one or more vehicle-mounted external camera whose fields of view are directed to various areas proximate to the vehicle;

FIG. 2 illustrates additional detail for an Impact Camera System (ICS);

FIG. 3 illustrates an exemplary on-board computer in which the present invention may be utilized; and

FIG. 4 is a flow-chart of exemplary steps taken by the present invention to visually record an impact to the vehicle.

### DETAILED DESCRIPTION OF THE PREFERRED EMBODIMENT

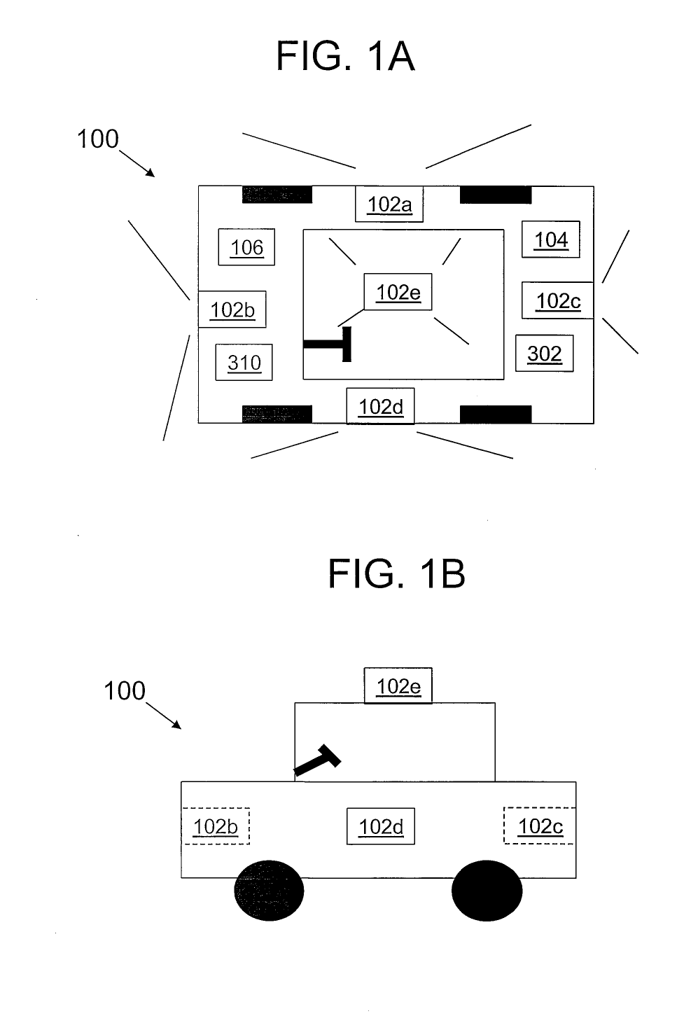

With reference now to the figures and in particular to FIGS. 1A-B, a vehicle 100 is presented. Note that while vehicle 100 is presented for exemplary purposes, and as a preferred embodiment, as an automobile, vehicle 100 may be any vehicle, including but not limited to trucks, buses, aircraft, water craft, construction equipment (e.g., forklifts, graders, etc.), agricultural equipment (e.g., tractors, combines, etc.), and any other vehicle capable of transporting passengers and/or material, and/or performing work during vehicle movement.

Vehicle 100 includes multiple vehicle-mounted cameras 102a-e. As depicted for exemplary purposes, vehicle-mounted cameras 102a-d have slightly overlapping directional fields of view, while vehicle-mounted camera 102e has a 360° field of view. Optionally, each vehicle-mounted camera 102 is also equipped with an audio microphone (not shown). Also located on vehicle 100 are an impact detection logic 104, an on-board computer 302, a camera feed logic 106, and an on-board video recorder 310, which together make up part of an Impact Camera System.

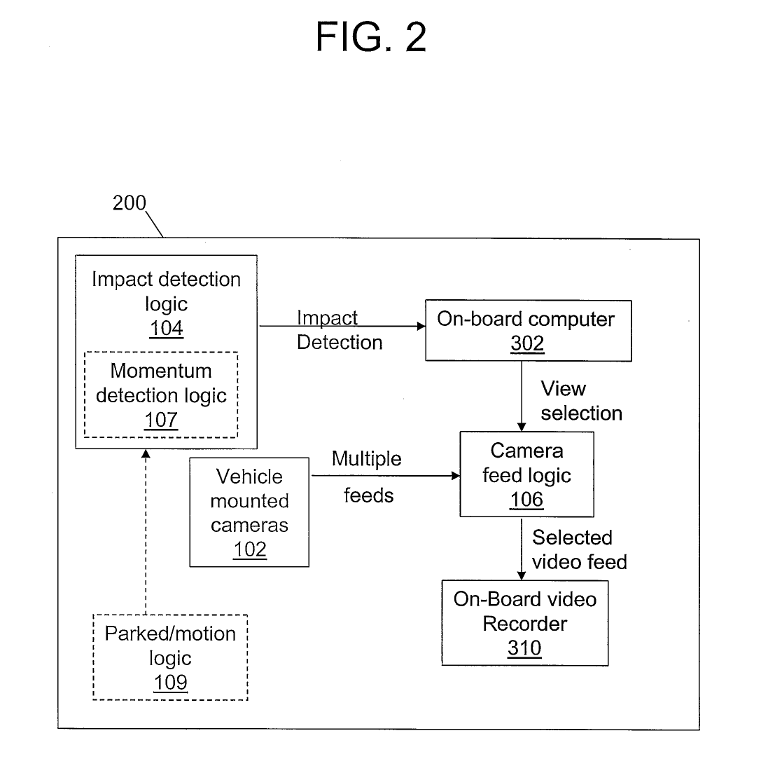

With reference now to FIG. 2, an exemplary Impact Camera System (ICS) 200 is depicted. In response to vehicle 100 being impacted with a force that is above a pre-determined level, impact detection logic 104 sends an impact detection signal to on-board computer 302. The pre-determined level is defined as an impact level of force that can be caused only by a moving object having a momentum that is equal to or greater than that caused by a motorized passenger vehicle, such as an automobile (but not a light motorcycle, etc.). Alternatively, the pre-determined level is defined as a lesser impact level of force caused by a shopping cart, motorcycle, etc. Thus, in either embodiment, an impact caused by a pedestrian, a thief breaking a window or door on the vehicle, a light baby carriage, etc., will not be sufficient to cause impact detection logic 104 to send the impact detection signal to the on-board computer 302. In a preferred embodiment, impact detection logic 104 is not only able to detect an impact force that exceeds the pre-determined level, but is also able to determine a direction, from which the impact force originated, through the use of an optional momentum detection logic 107 that has an ability to determine the direction from which the impact came. This direction detection may be accomplished by any means known to those skilled in the art, including but not limited to, a three-axis weighted strain gauge, an inertia detector, etc. In an alternative embodiment, a parked/motion logic 109 is able to detect that the vehicle is parked (not moving) and that the vehicle has been struck. Thus, if the vehicle is not moving, then a simple motion logic, such as a contact switch on a leaf or coil spring in the vehicle's suspension, can trigger a recording of a camera feed. By knowing that the vehicle is parked, then this contact switch can be assumed to be closed in response to a vehicle blow, rather than a pothole, bump, etc. that would close the contact during travel operations of the vehicle.

Once the on-board computer 302 receives the impact detection signal from the impact detection logic 104, and assuming that the impact detection logic 104 includes the momentum detection logic 107, then the on-board computer 302 sends a view selection signal to the camera feed logic 106. Coming into camera feed logic 106 are multiple video (and optionally audio) feeds from different vehicle-mounted cameras 102. Based on the direction from which the impact came, feed from that camera will be selected by the camera feed logic 106 for recording by on-board video recorder 310. For example, assume that another vehicle hit the front of vehicle 100 shown in FIG. 1A. In this example, feed from vehicle-mounted camera 102b would be selected, since vehicle-mounted camera 102b would have a field of view most likely to “see” the other vehicle. Alternatively, a feed from vehicle-mounted camera 102e may be selected, either as an alternative to the feed from vehicle-mounted camera 102b or as a supplemental feed to provide additional video information.

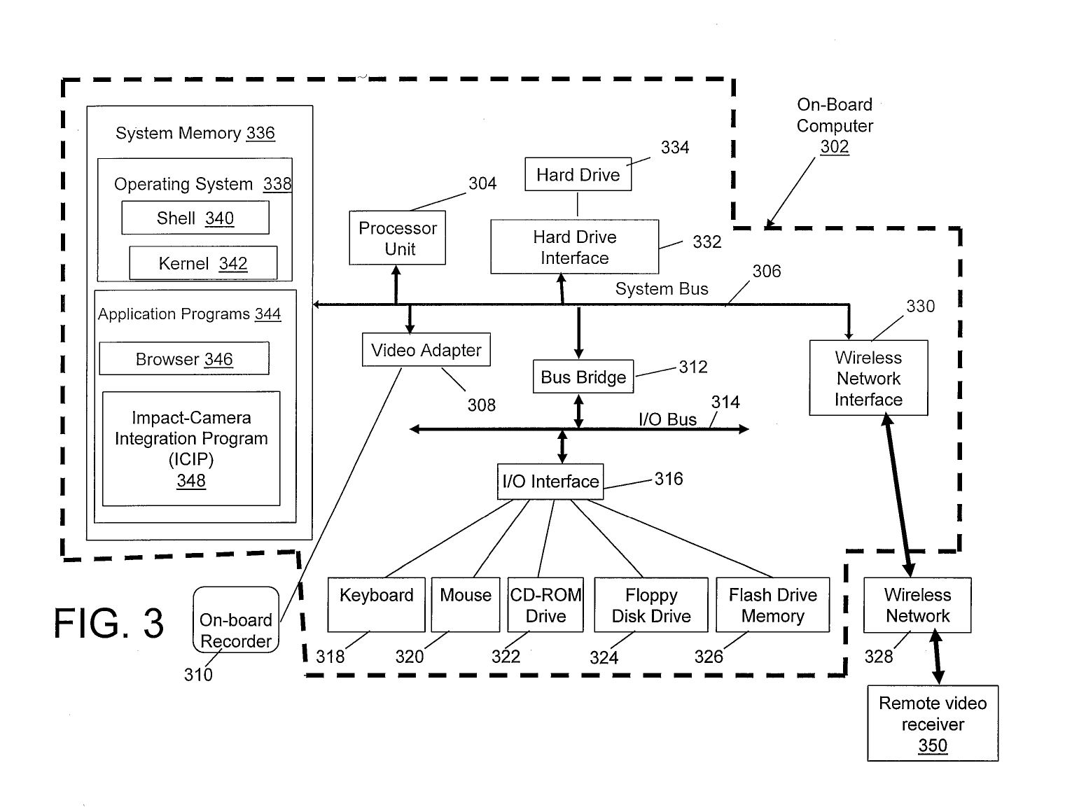

With reference now to FIG. 3, there is depicted a block diagram of an exemplary on-board computer 302, in which the present invention may be utilized. On-board computer 302 includes a processor unit 304 that is coupled to a system bus 306. A video adapter 308, which drives/supports a on-board video recorder 310, is also coupled to system bus 306. System bus 306 is coupled via a bus bridge 312 to an Input/Output (I/O) bus 314. An I/O interface 316 is coupled to I/O bus 314. I/O interface 316 affords communication with various I/O devices, including a keyboard 318, a mouse 320, a Compact Disk—Read Only Memory (CD-ROM) drive 322, a floppy disk drive 324, and a flash drive memory 326. The format of the ports connected to I/O interface 316 may be any known to those skilled in the art of computer architecture, including but not limited to Universal Serial Bus (USB) ports.

On-board computer 302 is able to communicate with a remote video receiver 350 via a wireless network 328 using a wireless network interface 330, which is coupled to system bus 306. Wireless network 328 may be any wireless network, including a cell phone based system, a satellite communication system, etc. Note the remote video receiver 350, which may be a computer, a cell phone, logic at a law enforcement office, etc., may utilize a same or substantially similar architecture as on-board computer 302.

A hard drive interface 332 is also coupled to system bus 306. Hard drive interface 332 interfaces with a hard drive 334. In a preferred embodiment, hard drive 334 populates a system memory 336, which is also coupled to system bus 306. System memory is defined as a lowest level of volatile memory in on-board computer 302. This volatile memory includes additional higher levels of volatile memory (not shown), including, but not limited to, cache memory, registers and buffers. Data that populates system memory 336 includes on-board computer 302's operating system (OS) 338 and application programs 344.

OS 338 includes a shell 340, for providing transparent user access to resources such as application programs 344. Generally, shell 340 is a program that provides an interpreter and an interface between the user and the operating system. More specifically, shell 340 executes commands that are entered into a command line user interface or from a file. Thus, shell 340 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338, including providing essential services required by other parts of OS 338 and application programs 344, including memory management, process and task management, disk management, and mouse and keyboard management.

Application programs 344 include a browser 346. Browser 346 includes program modules and instructions enabling a World Wide Web (WWW) client (i.e., on-board computer 302) to send and receive network messages to the Internet using HyperText Transfer Protocol (HTTP) messaging, thus enabling communication with wireless Internet Service Providers (ISPs), etc. (not shown).

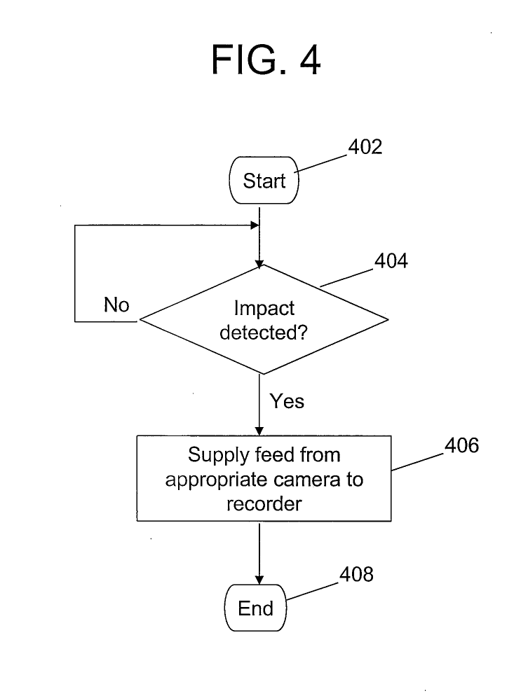

Application programs 344 in on-board computer 302's system memory also include an Impact-Camera Integration Program (ICIP) 348. ICIP 348 includes code for implementing the processes described in FIGS. 2 and 4.

The hardware elements depicted in on-board computer 302 are not intended to be exhaustive, but rather are representative to highlight essential components required by the present invention. For instance, on-board computer 302 may include alternate memory storage devices such as magnetic cassettes, Digital Versatile Disks (DVDs), Bernoulli cartridges, and the like. These and other variations are intended to be within the spirit and scope of the present invention.

With reference now to FIG. 4, a high-level flow-chart of exemplary steps taken by the present invention is presented. After initiator block 402, a query is made to determine if a the impact detection logic in the vehicle has detected an impact of a force that is above a pre-determined level (query block 404). This pre-determined level may be reached by the vehicle 100 (shown in FIG. 1A) being hit by another vehicle, either while vehicle 100 is parked, or alternatively, while vehicle 100 is moving. If so, then a video feed selection logic (e.g., camera feed logic 106 shown in FIG. 2) selects a video feed from an appropriate (left, right, front, rear, omnidirectional) camera, based on the direction from which the impact was delivered, and sends the selected video feed to the on-board camera for recording (block 406). Feed from the camera is recorded for any pre-determined period of time, ranging from a few seconds (if the on-board recorder is able to record only a limited amount of MPEG data) to an unlimited amount of time. The process thus ends at terminator block 408.

With reference again to query block 404, in an alternate embodiment, a video feed selection logic selects an appropriate video feed if a collision is determined to be imminent. This determination may be made by a speed/proximity combination logic, known to those skilled in the art, which determines that an impact is imminent based on the speed of an approaching object. By spooling up the video feed before the impact, relevant forensic evidence can be gathered by the vehicle-mounted cameras, such as the license plate of the other vehicle, road conditions, time of day, etc.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

The present invention thus presents a new and useful method, vehicle, system, and computer-readable medium for recording an impact to a vehicle. In a preferred embodiment, the method includes the steps of: detecting an impact to the vehicle; and in response to detecting the impact to the vehicle, recording a video feed from a vehicle-mounted camera, wherein the vehicle-mounted camera has a field of view that captures a source of the impact. Preferably, the impact has a force that exceeds a pre-determined level, such as that caused by another vehicle. The method may further include the step of recording an audio record of the impact. In one embodiment, the video feed is created by activating, from a plurality of vehicle-mounted cameras, a specific vehicle-mounted camera that has the field of view of captures the source of the impact, wherein the specific vehicle-mounted camera is chosen according to a direction from which the impact hit the vehicle. The video feed may be from a single omnidirectional vehicle-mounted camera. The vehicle may be any type of vehicle, including a transportation vehicle.

More specifically, the vehicle may include an impact detection logic that selectively detects an impact to the first vehicle, wherein the impact is determined by the impact detection mechanism to be of sufficient force to have been caused by an other vehicle traveling at a sufficient velocity to damage the first vehicle; at least one vehicle-mounted camera, wherein the at least one vehicle-mounted camera captures an image of the other vehicle in response to the impact detection mechanism selectively detecting the impact to the first vehicle; a momentum detection logic, wherein the momentum detection logic detects a direction from which the impact originated; a camera feed logic, wherein the camera feed logic selects a video feed from a plurality of vehicle-mounted cameras according to the direction from which the impact originated; an on-board video recorder for recording the image of the other vehicle; and a transmission means for transmitting the image of the other vehicle to a remote video receiver. The image of the other vehicle may be a moving video image.

The inventive system, which may installed in any land, air, or water based transportation vehicle, as well as non-transportation equipment, may include an impact detection logic; an impact detection mechanism that selectively detects an impact to the first vehicle, wherein the impact is determined by the impact detection mechanism to be of sufficient force to have been caused by an other vehicle traveling at a sufficient velocity to damage the first vehicle; at least one vehicle-mounted camera, wherein the at least one vehicle-mounted camera captures an image of the other vehicle in response to the impact detection mechanism selectively detecting the impact to the first vehicle; a momentum detection logic, wherein the momentum detection logic detects a direction from which the impact originated; a camera feed logic, wherein the camera feed logic selects a video feed from a plurality of vehicle-mounted cameras according to the direction from which the impact originated; a transmission means for transmitting the image of the other vehicle to a remote video receiver; and an on-board video recorder for recording the image of the other vehicle.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method for recording an impact to a vehicle, the method comprising:
detecting an impact to the vehicle; and
in response to detecting the impact to the vehicle, recording a video feed from a vehicle-mounted camera, wherein the vehicle-mounted camera has a field of view that captures a source of the impact.

2. The method of claim 1, wherein the impact has a force that exceeds a pre-determined level.

3. The method of claim 2, the force is caused by another vehicle.

4. The method of claim 1, further comprising:
recording an audio record of the impact.

5. The method of claim 1, wherein the video feed is created by activating, from a plurality of vehicle-mounted cameras, a specific vehicle-mounted camera that has the field of view of captures the source of the impact.

6. The method of claim 5, wherein the specific vehicle-mounted camera is chosen according to a direction from which the impact hit the vehicle.

7. The method of claim 1, wherein the video feed is from a single omnidirectional vehicle-mounted camera.

8. The method of claim 1, further comprising:
determining that an impact to the vehicle is imminent; and
in response to determining that the impact to the vehicle is imminent, initiating a recording of video feed from the vehicle-mounted camera that has the field of view that captures the source of the impact.

9. A vehicle comprising:
an impact detection logic that selectively detects an impact to the first vehicle, wherein the impact is determined by the impact detection mechanism to be of sufficient force to have been caused by an other vehicle traveling at a sufficient velocity to damage the first vehicle; and
at least one vehicle-mounted camera, wherein the at least one vehicle-mounted camera captures an image of the other vehicle in response to the impact detection mechanism selectively detecting the impact to the first vehicle.

10. The vehicle of claim 9, further comprising:
a momentum detection logic, wherein the momentum detection logic detects a direction from which the impact originated.

11. The vehicle of claim 10, further comprising:
a camera feed logic, wherein the camera feed logic selects a video feed from a plurality of vehicle-mounted cameras according to the direction from which the impact originated.

12. The vehicle of claim 10, further comprising:
a transmission means for transmitting the image of the other vehicle to a remote video receiver.

13. The vehicle of claim 10, wherein the image of the other vehicle is a moving video image.

14. The vehicle of claim 10, further comprising:
an on-board video recorder for recording the image of the other vehicle.

15. A system comprising:
an impact detection logic;
an impact detection mechanism that selectively detects an impact to the first vehicle, wherein the impact is determined by the impact detection mechanism to be of sufficient force to have been caused by an other vehicle traveling at a sufficient velocity to damage the first vehicle; and
at least one vehicle-mounted camera, wherein the at least one vehicle-mounted camera captures an image of the other vehicle in response to the impact detection mechanism selectively detecting the impact to the first vehicle.

16. The system of claim 15, further comprising:
a momentum detection logic, wherein the momentum detection logic detects a direction from which the impact originated.

17. The system of claim 16, further comprising:
a camera feed logic, wherein the camera feed logic selects a video feed from a plurality of vehicle-mounted cameras according to the direction from which the impact originated.

18. The system of claim 15, further comprising:
a transmission means for transmitting the image of the other vehicle to a remote video receiver.

19. The system of claim 15, wherein the image of the other vehicle is a moving video image.

20. The system of claim 15, further comprising:
an on-board video recorder for recording the image of the other vehicle.
